(19) United States
(12) Patent Application Publication
(10) Pub. No.: US 2009/0222491 A1
(43) Pub. Date: Sep. 3, 2009

(54) Systems and Methods for Layered Resource Management

(76) Inventors: Michael Larkin, San Jose, CA (US); Thomas Speeter, San Martin, CA (US)

Correspondence Address: CARR & FERRELL LLP, 2200 GENG ROAD, PALO ALTO, CA, 94303, US

(21) Appl. No.: 12/350,957

(22) Filed: Jan. 8, 2009

Related U.S. Application Data
(60) Provisional application No. 61/067,611, filed on Feb. 28, 2008.
(60) Provisional application No. 61/068,554, filed on Mar. 6, 2008.

(51) Int. Cl. G06F 17/30

(52) U.S. Cl. 707/200; 707/E17.01

(57) ABSTRACT

Systems and methods for encapsulating computing resources in one or more layers are provided. In some embodiments, a set of computing resources are encapsulated in a layer. The layer is mobile from a first storage to a second storage. A request for a specific computing resource is received by an application of a computing device. A determination is made whether the layer includes the requested computing resource. The request is processed if the layer includes the requested computing resource. The processed request is provided to the operating system of the computing device.

### CROSS REFERENCE TO RELATED APPLICATIONS

This application claims the priority benefit of U.S. Patent Application Ser. No. 61/067,611, a provisional patent application filed on Feb. 28, 2008 and entitled “System and Method for Layered Resource Management.” This application also claims the priority benefit of U.S. Patent Application Ser. No. 61/068,554, a provisional patent application filed on Mar. 6, 2008 and entitled “System and Method for Layered Resource Management.” The disclosures of all the above provisional patent applications are incorporated by reference herein.

### FIELD OF THE INVENTION

This invention relates generally to managing resources in a computing environment. More specifically, the invention relates to systems and methods for layered resource management in a computing environment.

### SUMMARY

Systems and methods for encapsulating computing resources in a layer are provided. In a first aspect, a method for layered resource management is given. A set of computing resources is encapsulated in a layer. The layer is configured to be mobile from a first storage to a second storage. A request for a specific computing resource is received by an application of a computing device. A determination is made whether the layer includes the requested computing resource. The request is processed if the layer includes the requested computing resource. The processed request is provided to an operating system of the computing device.

In a second aspect, another method for layered resource management is provided. Rules governing visibility of one or more computer resources are generated in a view. The view is configured to be moveable from one addressable storage to another addressable storage. A request for a specific computing resource is received by an application of a computing device. It is determined whether the view includes rules governing the visibility of the requested computing resource. If the view includes rules governing the visibility of the requested computing resource, the request is translated. The translated requested is provided to an operating system of the computing device.

In a third aspect, yet another method for layered resource management is given. Computing resources are encapsulating in a plurality of layers. Each layer is configured to be portable from one addressable storage to another addressable storage. Elevations are assigned to each of the plurality of layers. A composite layer is established based on the elevations. A request for a specific computing resource is received from an application of a computing device. A determination is made whether the composite layer includes the requested computing resource. If the composite layer includes the requested computing resource, the request is translated. The translated request is transmitted to the operating system of the computing device.

In a fourth aspect, a method is provided. An initial request for a computing resource that is encapsulated in a layer is transmitted. A modified request for the computing resource is received, the modified request having been modified by a supervisor that intercepted the initial request. The modified request for the computing resource is fulfilled.

In a fifth aspect, another method for layered resource management is given. A set of computing resources is encapsulated in a plurality of layers. Each layer is configured to be transferrable from a first storage to a second storage. A request for a specific computing resource is received by an application of a computing device. It is determined whether one of the plurality of layers includes the requested computing resource. An identification is made as to which of the plurality of layers includes the requested computing resource. The request is translated if one of the plurality of layers includes the requested computing resource. The translated request is transmitted to an operating system of the computing device.

In a sixth aspect, a computer readable storage medium storing instructions is provided. When executed by a computer, the instructions cause the computer to perform a method for layered resource management. A set of computer resources are encapsulated in a layer. The layer is configured to be mobile from a first storage to a second storage. A request is received for a specific computer resource by an application of the computer. It is determined whether the layer includes the requested computing resource. The request is processed if the layer includes the requested computing resource. The processed request is provided to an operating system of the computer.

### BRIEF DESCRIPTION OF THE DRAWINGS

FIG. 1 is a flowchart depicting a method of using computing resources encapsulated in a layer.

FIG. 2 is a flowchart depicting a method of using a view governing visibility of a computing resource.

FIG. 3 is a flowchart depicting a method of using computing resources encapsulated in a plurality of layers.

FIG. 4 is a flowchart depicting a method for using layers and views with a supervisor.

FIG. 5 is a block diagram of a method of using layered management.

FIG. 6 is a block diagram of a further method of using layered management.

FIG. 7 is a diagram of an exemplary computing device according to various embodiments.

### DETAILED DESCRIPTION

The embodiments discussed herein are illustrative examples of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the scope of the present invention. Hence, these descriptions and drawings should not be considered in a limiting sense, as it is understood that the present invention is in no way limited to only the embodiments illustrated.

A typical computing resource that most computer users are familiar with is a file. A file resource represents the lowest common denominator type of resource. Files may be used to model a binary program, a picture or image file, a music file, a data file, or document file. It is possible to model almost every type of resource on a computer by only using files to represent every resource.

However, this approach has some limitations. There are a limited number of operations that are applicable to all types of file resources. Using file resources to embody any arbitrary type off data leads to a limitation on the breadth of operations applicable to them.

This restriction can be alleviated by permitting resources to be subclassed or derived. For example, picture files can be derived to picture resources, and audio files can be derived to audio resources. By deriving these subclasses, it is possible to take advantage of the additional specificity and allow more operations that may be performed to a computing resource. Computing resources may be subclassed to any arbitrary depth.

Layers encapsulate a set of computing resources along with various metadata and configuration information. In a preferred embodiment, a layer has the following characteristics: autonomy, consistency, mobility, self-describing, and neutrally homed. Autonomous layers are self-sufficient and do not rely on resources encapsulated in other layers. Consistent layers do not have contradictions in the metadata related to a layer, which in turn do not induce ambiguities related to the contents encapsulated in the layer. Layers may have mobility and may be moved from one storage root to another. A storage root may be a parent directory from which the layer may be accessed. Layers may be self-describing, that is, having sufficiently descriptive metadata such that there are no ambiguities resulting from applying this layer in a vacuum. Neutrally homed layers do not have dependencies on the underlying storage type. The layers are configured to be moved from one addressable storage to another addressable storage.

Layers may optionally be assigned attributes that influence the way in which a computing system interacts with the layer. Some attributes may include: read only, active/inactive, owner/contact information, and write target layer. When marked with the read only attribute, the layer's contents cannot be changed. The active/inactive attribute can be used to indicate if a layer is currently loaded on the computer. The owner/contact information attribute can be used to store contact information about the owner of the layer's contents. This attribute may be used by system administrators to delegate responsibility for a given layer or set of layers to individuals with domain expertise in the area relevant to the contents of the layer. The write target layer attribute indicates that the layer will be a default recipient of new resource creation.

Layers may be packed in several ways, including zip files, disk image files, or discrete files. Layers may be distributed to target systems by copying their contents, or by centrally storing these layers on a file server or other accessible storage.

Layers may be used for many different purposes. One purpose of a layer is to encapsulate an application and its constituent required resources to provide mobility. In other embodiments, encapsulating computing resources in a layer may be used to provide personalization of a user environment, a backup to a fixed point in time, a security policy, language support, or to add patches against layers containing applications. In addition, layers may be used in conjunction with virtual machines (e.g., process virtual machines), in order to keep track of resources that are required for execution of the application.

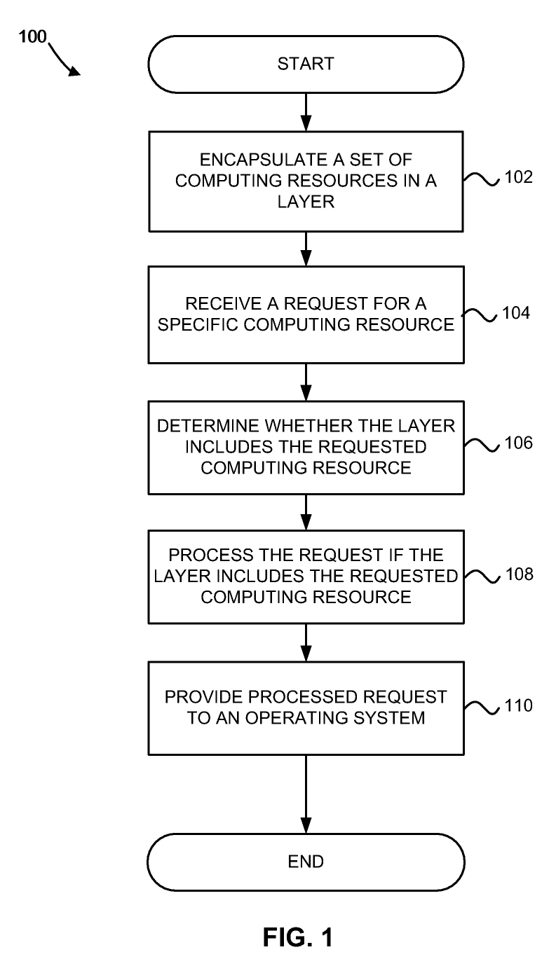

FIG. 1 is a flow chart depicting a method 100 of using computing resources encapsulated in a layer. In step 102, a set of computing resources are encapsulated in a layer. This can be accomplished by a variety of methods. In an exemplary method, the resources may be encapsulated in a layer by resource monitoring. In this method, the file system and resource activity are monitored, and a catalog and set of resources corresponding to a rule or set of rules are created. In another exemplary method, the resources may be encapsulated by explicit definition. In this method, each resource to be included in a layer is explicitly enumerated, either individually, via a rule, or via a set of rules. In some embodiments, encapsulating a set of computing resources in a layer further includes encapsulating the metadata associated with the set of computing resources. A layer can have computing resources, associated metadata, configuration data, or any combination thereof.

Still referring to FIG. 1, in step 104, a request for a specific computing resource is received from an application of a computing device. In some exemplary embodiments, receiving the request for a specific computing resource includes intercepting an I/O request issued by the application of the computing device. Typically, the interception occurs prior to an operating system of the computing device receiving the I/O request. In step 106, it is determined whether the layer includes the requested computing resource. In step 108, the request is processed if the layer includes the requested computing resource. Processing the request can include translating, modifying, transforming and/or virtualizing some or all of the request. In step 110, the processed request is provided to an operating system of the computing device.

In some embodiments, the method 100 further includes identifying each computing resource of the set of computing resources that are encapsulated in the layer. Also, the method 100 can further include cataloging the identified computing resources in a catalog. In some embodiments, the method 100 can also include normalizing any intercepted I/O request from the application of the computing device.

Views are dynamically generated catalogs of resources. Similar to layers, views are configured to be moved from one addressable storage to another addressable storage. Views may be rule based or be explicitly defined. Rule based views govern the visibility of a computing resource according to a rule or set of rules. For example, a rule based view may have one rule, which is “always make visible and elevate any resources from layer 1 whose names are A, B, or C.” In this example, composite layers including this rule based view would always make visible and elevate any resources from layer 1 whose names are A, B, or C, provided there is not a view with a higher elevation and conflicting visibility instructions in the composite layer.

Explicitly defined views may make visible and elevate specific resources. For example, an explicitly defined view may always make visible and elevate a resource named D in layer 2. In this example, composite layers including this explicitly enumerated view would always make visible and elevate resource D in layer 2, provided there is not a view with a higher elevation and conflicting visibility instructions in the composite layer.

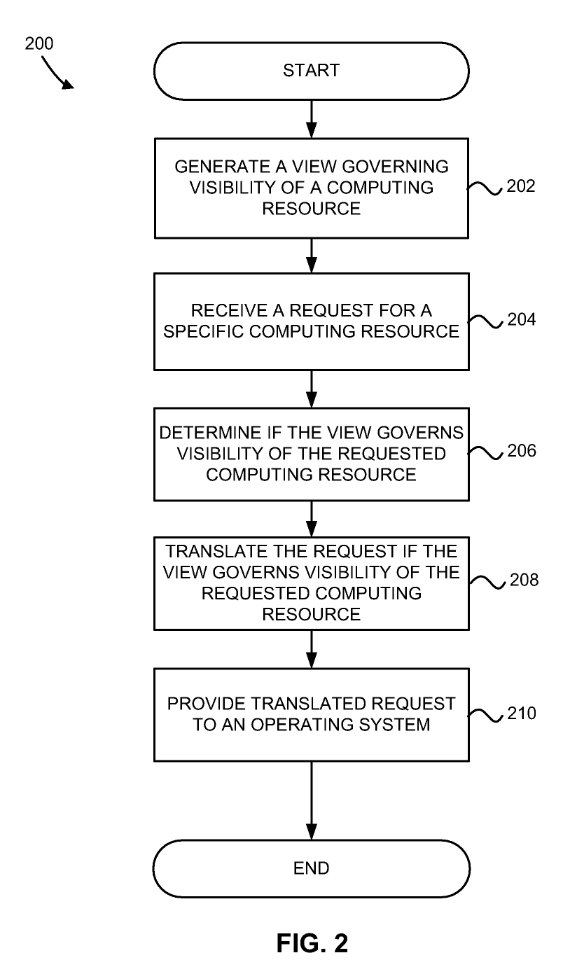

FIG. 2 is a flowchart depicting a method 200 of using view governing visibility of a computing resource. In step 202, a view governing visibility of a computing resource is generated. In step 204, a request for a specific computing resource is received from an application of the computing device. In step 206, it is determined if the view governs visibility of the specific computing resource. In step 208, the resource is translated if the view governs visibility of the requested specific computing resource. In step 210, the translated request is provided to an operating system of the computing device. In some embodiments, the method 200 includes assigning an elevation to one or more of the rules governing visibility of a computing resource.

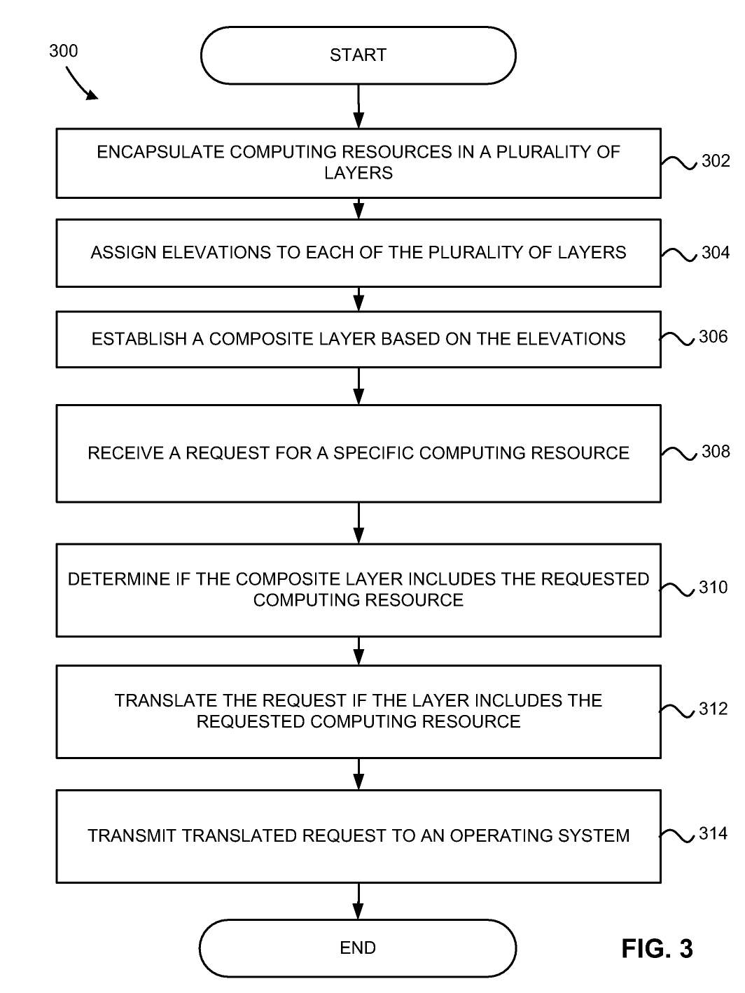

FIG. 3 is a flowchart depicting a method 300 of using computing resources encapsulated in a plurality of layers. In step 302, computing resources are encapsulated in a plurality of layers for layered resource management. Each layer is configured to be moved from one addressable storage to another addressable storage. In exemplary embodiments, one of the layers may provide a patch to another layer.

In step 304, priority elevations are assigned to each of the plurality of layers. The assigned elevations correspond to each layer's position in the composite layer. Layers with higher priority elevations can take precedence over layers with lower priority elevations.

In step 306, a composite layer based on the layer elevations and the view rules is established. The composite layer includes all of the computing resources in the plurality of layers and represents the entire set of resources available to any given application. In situations where two or more layers encapsulate a resource having the same name, the composite layer uses the resource from the layer with the highest priority elevation. For example, consider a composite layer having two layers, layer 1 and layer 2, with layer 1 having the higher priority elevation. Layer 1 has resources A, C, and D, and layer 2 has resources B, C, and E. The resulting composite layer would have resources A, B, C, D, and E. The composite layer would have resources A, C and D from layer 1, and resources B and E from layer 2. The composite layer has resource C from layer 1 and not layer 2, because layer 1 has a higher priority elevation.

In step 308, a request for a specific computing resource is received from an application of a computing device. Receiving the request can also include intercepting the request by a supervisor associated with a layer. In some embodiments, the request is intercepted prior to it being received by an operating system of a computing device. In step 310, it is determined if the composite layer includes the requested computing resource. In step 312, the resource is translated if the composite layer includes the requested computing resource. In step 314, the translated request is provided to an operating system of the computing device.

Layers may be locked. Launched applications that have their executables located in a given locked layer can only utilize resource from that layer and layers with a lower elevation.

Layers may be isolated. Launched applications that have their executables located in a given isolated layer can only utilize resources from that layer.

Layer may be kept in sync with each other. In some embodiments, the layers may not be continuously maintained in sync, but may be periodically kept in sync. For example, consider two layers that a user wants to keep in sync each other, layer A and layer B. The user defines either layer A or layer B to be the “master” layer. The resource catalog enumerated each resource in a layer. By using the resource catalog, the resources in layer B can be kept in sync with the resources in layer A.

Layers may be cached. If an application creates or modifies a resource in a master layer, this operation may be contemporaneously applied to a cache layer. By applying these changes simultaneously, the cache layer will always be kept in sync with the master layer. Layer caching is particularly useful when the master layer is located on a slower storage link than the cache layer. The cache layer may be assigned a higher elevation, thus providing the system with a high-speed local cache layer while still keeping the master layer up to date.

It may be desirable for the source layer for a given resource to be overridden, sourced from a fixed location or layer rather than calculated according to the layer priority elevations. Using views provides this capability.

The following example demonstrates how views can be used to override the source layer for a given resource. Using the previous example of composite layers, consider a composite layer having two layers, layer 1 and layer 2, with layer 1 having the higher priority elevation. Layer 1 has resources A, C, and D, and layer 2 has resources B, C, and E. Now we include a view to the composite layer, named view 1, which is assigned a higher priority elevation than layer 1 and layer 2. View 1 only has one rule, which is “always make visible and elevate any resources from layer 2 whose names are A, B, or C. The resulting composite layer would have resources A, B, C, D, and E. The composite layer would have resources A, and D from layer 1, and resources B, C and E from layer 2. The composite layer has resource C from layer 2, because view 1 has a higher priority elevation than layer 1.

In other embodiments, the method 300 in FIG. 3 may further include encapsulating rules governing visibility of one or more computer resources into one or more views, with the one or more views configured to be moved from one addressable storage to another addressable storage. The views are assigned priority elevations. A composite layer of the plurality of layers and the one or more views is determined based on the priority elevations assigned to each of the layers and view(s). A request for a specific computing resource is received and it is determined if the composite layer of the plurality of layers and the one or more views includes the specific computing resource. The resource is translated if the composite layer of the plurality of layers and the one or more views includes the requested specific computing resource. The translated request is then provided to an operating system.

In other embodiments, the composite layer may include one layer and one or more views. The composite layer may also alternatively include a plurality of views and no layers.

Layers and views may be further organized into containers. A container is a loose collection of layers. Attributes of the containers can be managed. Security settings, caching policies, and mobility can be applied to the container as a whole. Containers can be moved from one host computer to another transparently. Operations may also be applied to containers, including container creation, layer definition, layer deletion, cloning, combination, fracturing, flattening, layer adjustment, transformations, copying, and moving. Container creation is the creation of an empty container with no layers. Layer definition is the defining of a layer and associating that layer with a container. Layer deletion is the removal of a layer from a container. Layer cloning is the duplication of a container's metadata, but not its constituent layer contents. Layer combining is the combining of two or more selected containers into one, resulting in a new container having all layers from all original containers. Fracturing is the splitting of a container into two or more containers, based on rules supplied by the user or system administrator. Flattening is the combing of all layers in a container into a single layer, resulting in a container with one layer that contains all of the resources previously contained in the plurality of layers originally in the container. Applying an operation to a container may result in layers being changed, shifted, or modified in some other manner.

In some embodiments, the method 300 of FIG. 3 comprises aggregating one or more layers into a container. The container is configured to be moveable from the first addressable storage to the second addressable storage. In some embodiments, the container comprises metadata regarding an identification of the one or more layers in the container, metadata of the assigned elevations of each of the one or more layers in the container, and any combination thereof.

Layer adjustments may also be performed to the layers at the container level. During layer adjustment, the elevation of one or more layers may be altered, possibly resulting in a different aggregate resource set of the container.

The system may be managed at the container level, and not at the layer level. However, it is permissible to have a container with a single layer defined.

A supervisor may be used to utilize layers and views in a computing system. As such, a supervisor may be used to manage containers including one or more layers. A supervisor of a layer and/or container may be configured based on an operating environment of a system. In an exemplary embodiment, a supervisor is implemented as a kernel mode (privileged mode) interceptor and a translator pipeline. Alternatively, the supervisor may be implemented entirely in kernel mode, entirely in user mode, or any combination of kernel mode and user mode. In some embodiments, user mode may include, for example, unprivileged mode. The interceptor receives I/O from an operating system, normalizes the request into a standard structure understandable by the translators, and then passes these normalized requests through a sequence of translators. A translator pipeline is a sequence of translators. In other embodiments, the supervisor may have multiple interceptors and multiple translator pipelines. Translators are executable code modules that act as callback functions as the resource request passes through the translator pipeline.

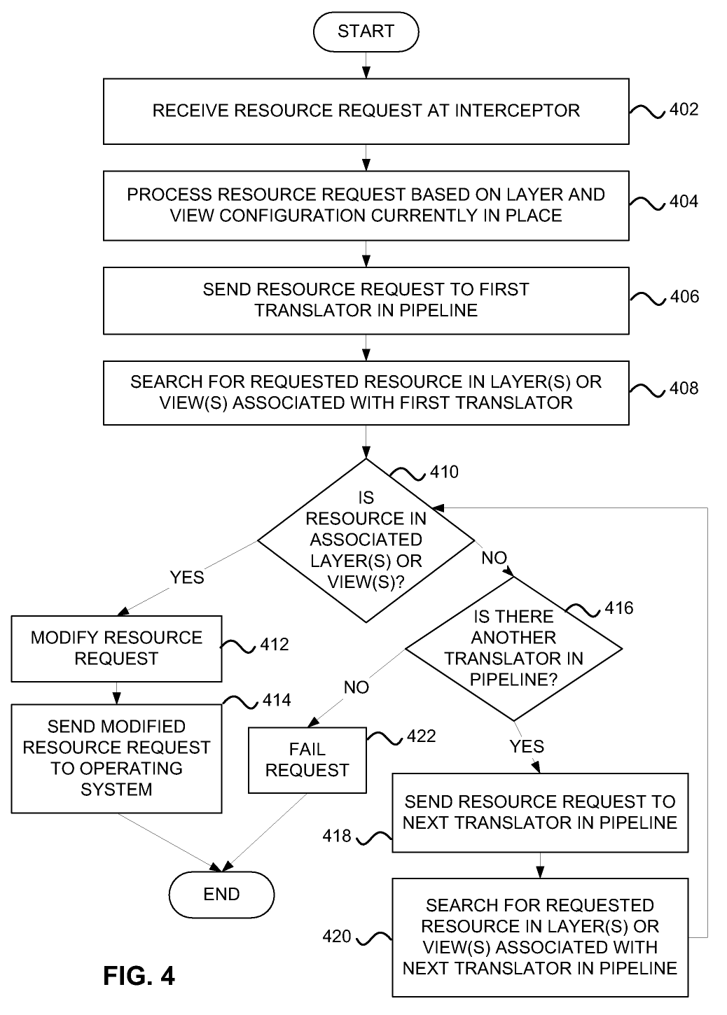

FIG. 4 is a flowchart depicting a method for using layers and views. In this method, the supervisor is implemented as a privileged mode (kernel mode) interceptor and a translator pipeline. In step 402, a resource request is received at the interceptor. In step 404, the resource request is processed based on layer and view configuration currently in place. In step 406, the resource request is sent to the first translator in the pipeline.

In step 408, the system searches for the requested resource in the layer(s) or view(s) that are associated with the first translator. Translators may be associated with multiple layers and views, even in different containers. Conversely, multiple translators may be associated to one layer.

In step 410, it is determined if the resource is in the layer(s) or view(s) associated with the first translator. If it is determined that the resource is in a layer or view associated with the first translator, the resource request is modified in step 412. In step 414, the modified resource request is sent to the operating system. The resource request is modified in step 412 such that the operating system will use the resource in the layer or view associated with the translator, instead of the resource identified in the unmodified resource request.

If it is determined that the resource is not in any of the layer(s) or view(s) associated with the first translator, in step 416, the system determines if there is another translator in the pipeline. If there is another translator, in step 418 the resource request is sent to the next translator in the pipeline. In step 420, the system searches for the requested resource in the layer(s) or view(s) that are associated with the next translator in the pipeline. This process is repeated until either the requested resource is found in a layer or view associated with a translator (in which case the steps 412 and 414 are performed), or the resource is not found in any of the layer(s) and view(s) associated with every translator in the pipeline (in which case the system fails the request in step 422).

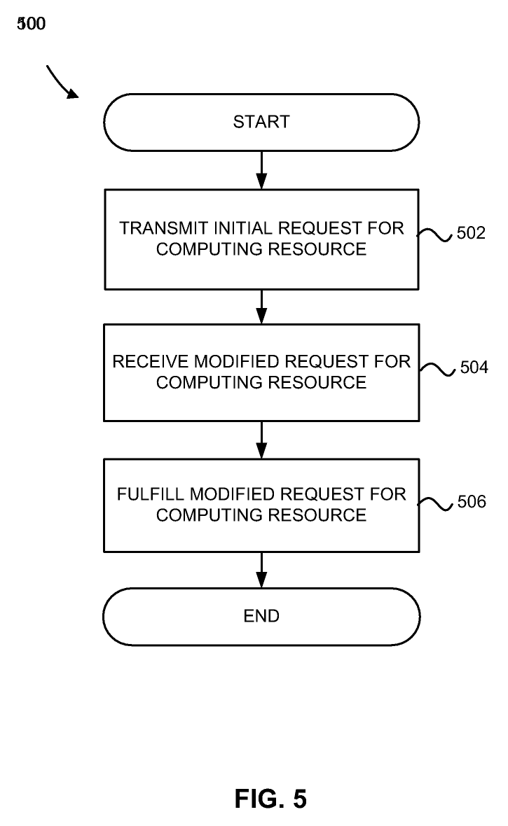

FIG. 5 is a block diagram of a method 500 of using layered management. In step 502, an initial request for a computing resource is transmitted. The computing resource is encapsulated in a layer. A modified request for the computing resource is received at step 504. In some embodiments, the modified request includes a mapping to where the computing resource is presented located in the layer. In step 506, the modified request for the computing resource is fulfilled.

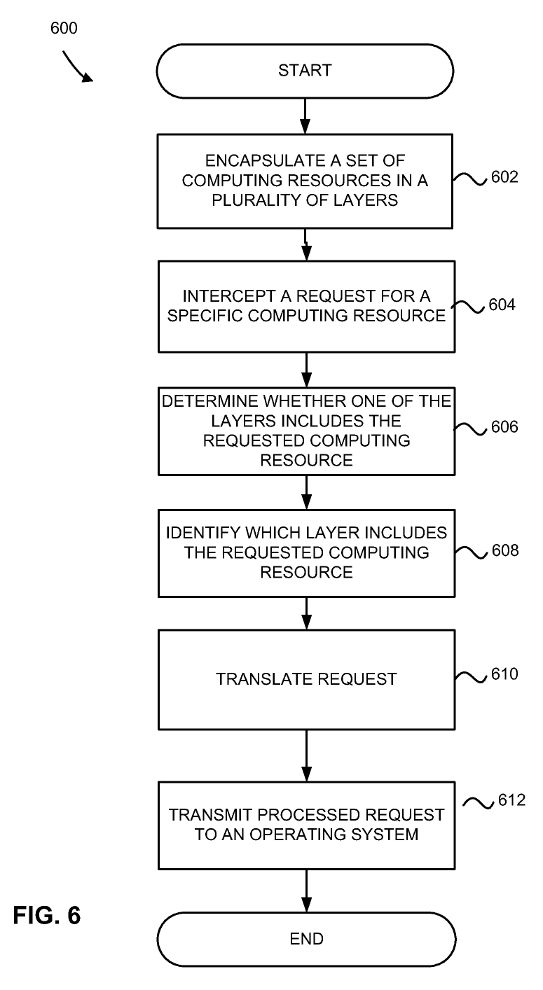

FIG. 6 is a block diagram of a method 600 of using layered management. In step 602, a set of computing resources is encapsulated in a plurality of layers. Each layer is configured to be transferrable from a first storage to a second storage. In step 604, a request for a specific computing resource is intercepted by an application of a computing device. In step 606, it is determined whether one of the plurality of layers includes the requested computing resource. In step 608, it is identified which of the plurality of layers includes the requested computing resource. In step 610, the request is translated if one of the plurality of layers includes the requested computing resource. In step 612, the translated request is transmitted to an operating system of the computing device.

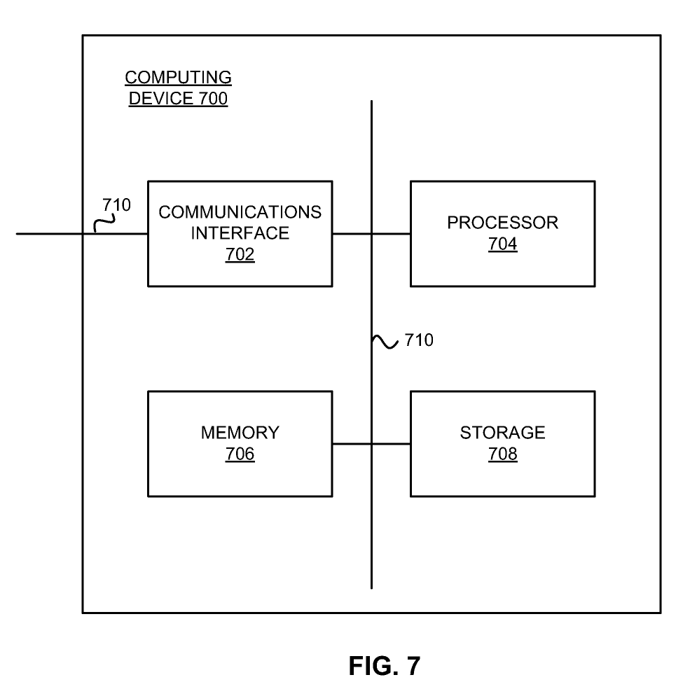

FIG. 7 is a block diagram of an exemplary computing device 700 that may implement layered resource management according to one or more of the methods described herein. The computing device 700 includes a communications interface 702, a processor 704, a memory 706, and storage 708, which are all coupled to a bus 710. The bus 710 allows communications among the communications interface 702, the processor 704, the memory 706, and the storage 708.

The above-described functions and/or methods may include instructions that may be retrieved and executed by the processor 704 to generate and manage layers, views and/or containers. These instructions may include software modules that integrate with both an operating system and an application. The instructions may be stored in memory 706, storage 708, and any combination thereof. In some embodiments, instructions for a virtual machine (e.g., a process virtual machine) may be stored in memory 706 and/or storage 708 and executed by processor 704. The memory 706 permanently or temporarily stores data. Some examples of the memory 706 are RAM and ROM. The storage 708 also permanently or temporarily stores data. Some examples of the storage 708 are hard disks, disk drives, and USB flash drives.

The embodiments discussed herein are illustrative. As these embodiments are described with reference to illustrations, various modifications or adaptations of the methods and/or specific structures described may become apparent to those skilled in the art. The above-described components and functions can be comprised of instructions that are stored on a computer-readable storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with the invention. Those skilled in the art are familiar with instructions, processor(s), and storage media.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A method for layered resource management, comprising:
encapsulating a set of computing resources in a layer, the layer configured to be mobile from a first storage to a second storage;
receiving a request for a specific computing resource by an application of a computing device;
determining whether the layer includes the requested computing resource;
processing the request if the layer includes the requested computing resource; and
providing the processed request to an operating system of the computing device.

2. The method of claim 1 wherein processing the request further comprises translating the request.

3. The method of claim 1 wherein processing the request further comprises modifying the request.

4. The method of claim 1 wherein processing the request further comprising transforming the request.

5. The method of claim 1, further comprising:
identifying each computing resource of the set of computing resources encapsulated in the layer; and
cataloging the identified computing resources in a catalog.

6. The method of claim 1 wherein receiving a request for a specific computing resource further comprises intercepting an I/O request issued by the application of the computing device.

7. The method of claim 6, further comprising normalizing the intercepted I/O request.

8. The method of claim 1, wherein the layer further comprises metadata associated with the set of computing resources.

9. The method of claim 8, wherein encapsulating a set of computing resources in a layer further comprising encapsulating the metadata associated with the set of computing resources.

10. A method for layered resource management, comprising:
generating a view governing visibility of one or more computer resources in a view, the view configured to be moveable from one addressable storage to another addressable storage;
receiving a request for a specific computing resource by an application of a computing device;
determining if the view includes rules governing the visibility of the requested computing resource;
translating the request if the view includes rules governing the visibility of the requested computing resource; and
providing the translated request to an operating system of the computing device.

11. The method of claim 10, further comprising assigning an elevation to one or more of the rules.

12. A method for layered resource management, comprising:
encapsulating computing resources in a plurality of layers, each layer configured to be portable from one addressable storage to another addressable storage;
assigning elevations to each of the plurality of layers;
establishing a composite layer based on the elevations;
receiving a request for a specific computing resource by an application of a computing device;
determining if the composite layer includes the requested computing resource;
translating the request if the composite layer includes the requested computing resource; and
transmitting the translated request to the operating system of the computing device.

13. The method of claim 12, further comprising:
encapsulating rules governing visibility of one or more computer resources into one or more views, the one or more views configured to be moved from one addressable storage to another addressable storage;
assigning elevations to the one or more views; and
determining a composite layer of the plurality of layers and the one or more views based on the assigned elevations.

14. The method of claim 12, further comprising aggregating one or more layers into a container, the container configured to be moveable from the first addressable storage to the second addressable storage.

15. The method of claim 14, wherein the container comprises metadata regarding an identification of the one or more layers in the container and the assigned elevations of each of the one or more layers in the container.

16. The method of claim 12, wherein receiving a request for the specific computing resource further comprises intercepting the request by a supervisor.

17. A method comprising:
transmitting an initial request for a computing resource that is encapsulated in a layer;
receiving a modified request for the computing resource; and
fulfilling the modified request for the computing resource.

18. The method of claim 17, wherein the modified request includes a mapping to where the computing resource is presently located in the layer.

19. A method for layered resource management, comprising:
encapsulating a set of computing resources in a plurality of layers, each layer configured to be transferrable from a first storage to a second storage;
intercepting a request for a specific computing resource by an application of a computing device;
determining whether one of the plurality of layers includes the requested computing resource;
identifying which of the plurality of layers includes the requested computing resource;
translating the request if one of the plurality of layers includes the requested computing resource; and
transmitting the translated request to an operating system of the computing device.

20. A computer readable storage medium storing instructions that, when executed by a computer, cause the computer to perform a method for layered resource management, the method comprising:
encapsulating a set of computing resources in a layer, the layer configured to be mobile from a first storage to a second storage;
receiving a request for a specific computing resource by an application of a computer;
determining whether the layer includes the requested computing resource;
processing the request if the layer includes the requested computing resource; and
providing the processed request to an operating system of the computer.
